(19) United States
(12) Patent Application Publication
(10) Pub. No.: US 2010/0114718 A1
(43) Pub. Date: May 6, 2010

(54) Function-Based Embedded Advertising in Software

(76) Inventor: Nam-Joon Cho, Stanford, CA (US)

Correspondence Address: MORGAN, LEWIS & BOCKIUS, LLP. (PA), 2 PALO ALTO SQUARE, 3000 EL CAMINO REAL, SUITE 700, PALO ALTO, CA, 94306, US

(21) Appl. No.: 12/264,179

(22) Filed: Nov. 3, 2008

(51) Int. Cl. G06Q 30/00

(52) U.S. Cl. 705/14.72

(57) ABSTRACT

A computer-implemented method executes a function of a software application that includes a plurality of functions. Respective functions of the plurality of functions correspond to respective commands of a plurality of commands associated with the software application. In the method, a respective command of the plurality of commands is received. In response to the received respective command, an advertisement is displayed and the respective function corresponding to the received respective command is performed

### TECHNICAL FIELD

The disclosed embodiments relate generally to software that displays advertising, and more particularly, to advertising displays associated with execution of a function in a software application.

### BACKGROUND

Software piracy costs the software industry billions of dollars a year in lost revenue. The lost revenue caused by piracy results in higher prices, which make software less accessible to potential software users with limited means. Software that displays advertising offers an alternative business model for software companies. Traditionally, however, advertising displayed by software applications is displayed based on content. For example, a pop-up banner advertisement may be displayed to a user attempting to access a particular web page with web browser software. The pop-up banner thus is associated with the particular web page and its content. In another example, an email application may display advertisements based on the content of an email accessed by a user. Content-based advertising is not practical for many software applications, however. For example, content-based advertising is not viable for software applications that process content or data stored locally on a computer because the content or data is not accessible to advertisers. Furthermore, the unexpected display of pop-up banners and other types of content-based advertisements results in a jarring, unpleasant user experience. Accordingly, there is a need for innovative methods of using software to display advertising.

### SUMMARY

In some embodiments, a computer-implemented method executes a function of a software application that includes a plurality of functions. Respective functions of the plurality of functions correspond to respective commands of a plurality of commands associated with the software application. In the method, a respective command of the plurality of commands is received. In response to the received respective command, an advertisement is displayed and the respective function corresponding to the received respective command is performed.

In some embodiments, a computer system includes memory, a display, one or more processors, and one or more programs stored in the memory and configured for execution by the one or more processors. The one or more programs include instructions to receive a command of a plurality of commands associated with a software application. Respective commands of the plurality of commands correspond to respective functions of a plurality of functions included in the software application. The one or more programs also include instructions to display an advertisement in response to the received command and instructions to perform the respective function corresponding to the received command.

In some embodiments, a computer readable storage medium stores one or more programs configured to be executed by a computer system. The one or more programs include instructions to receive a command of a plurality of commands associated with a software application. Respective commands of the plurality of commands correspond to respective functions of a plurality of functions included in the software application. The one or more programs also include instructions to display an advertisement in response to the received command and instructions to perform the respective function corresponding to the received command.

### BRIEF DESCRIPTION OF THE DRAWINGS

FIGS. 1A-1E are schematic screenshots of a desktop user interface in accordance with some embodiments.

FIGS. 2A-2D are schematic screenshots of a user interface associated with a software application in accordance with some embodiments.

FIG. 3 is a block diagram illustrating a networked computer system in accordance with some embodiments.

FIG. 4 is a block diagram illustrating a computer or computer controlled device in accordance with some embodiments.

FIG. 5 is a block diagram illustrating a server computer in accordance with some embodiments.

FIG. 6A is a diagram illustrating a table that maps functions to commands and advertisements in accordance with some embodiments.

FIG. 6B is a diagram illustrating a deletion summary table in accordance with some embodiments.

FIG. 7A is a flow diagram illustrating a computer-implemented method of deleting a file in accordance with some embodiments.

FIG. 7B is a flow diagram illustrating a computer-implemented method of executing a particular function in a software application in accordance with some embodiments.

Like reference numerals refer to corresponding parts throughout the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments.

To allow software developers to implement advertising-based business models while avoiding problems associated with content-based advertising, a software application may be configured such that an advertisement is displayed in response to user selection of a command associated with a function to be performed by the software application. In some embodiments, the advertisement is displayed prior to execution of the function and the user is required to acknowledge the advertisement before the function is executed. Alternatively, the advertisement is displayed while the function is executed or after the function has been executed.

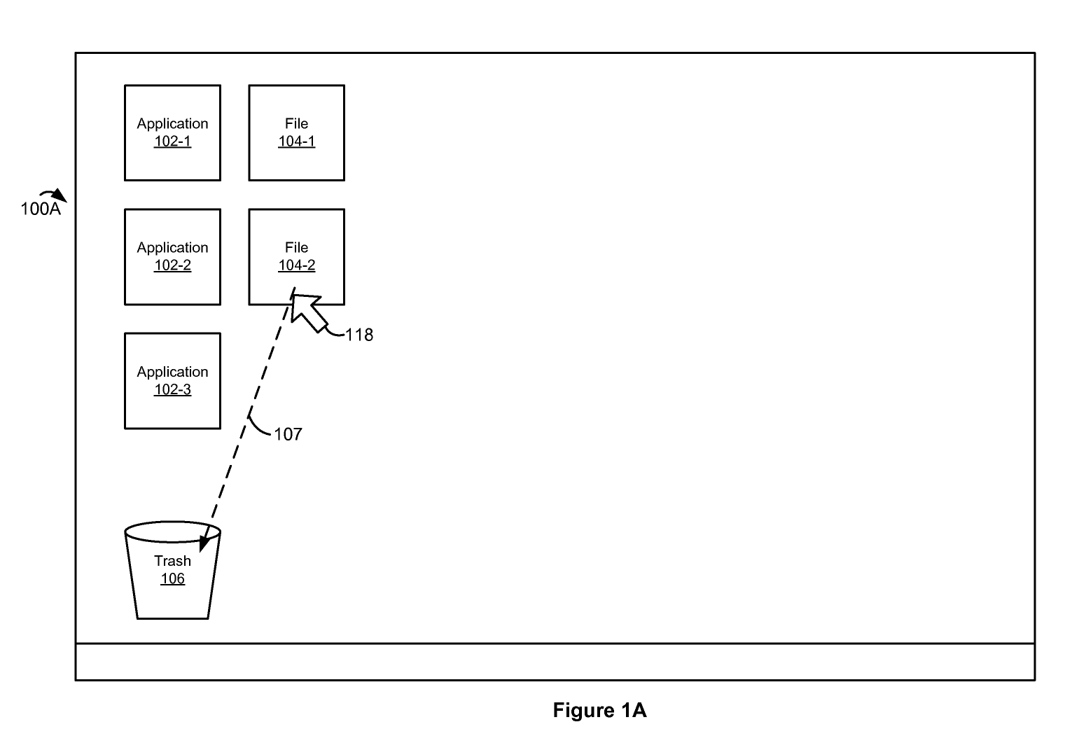

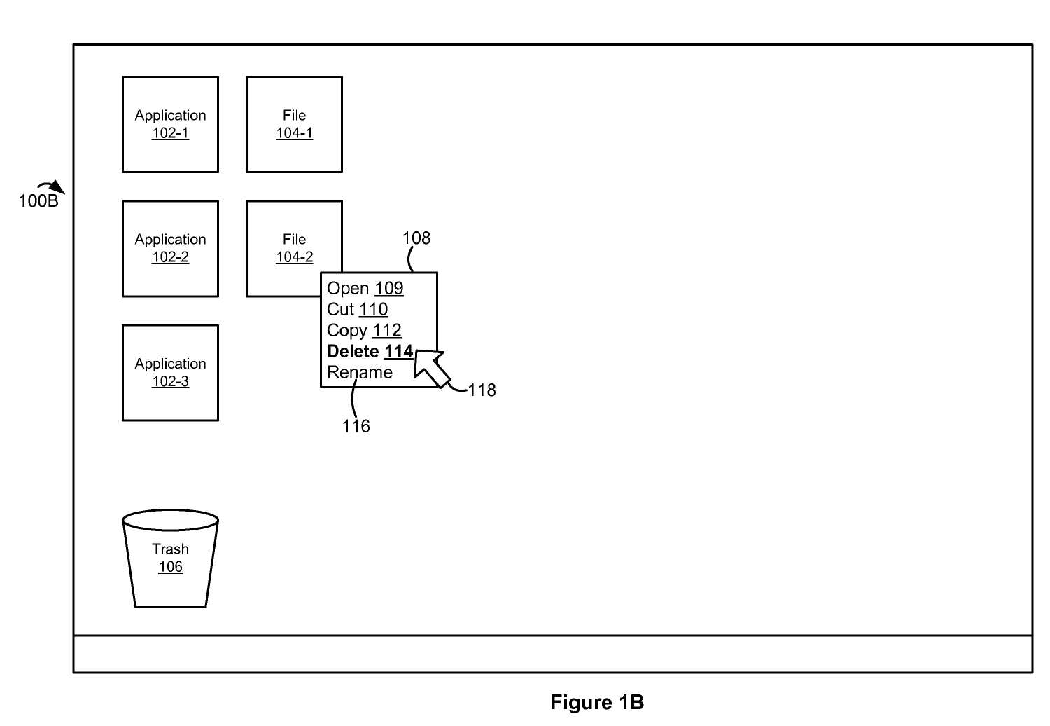

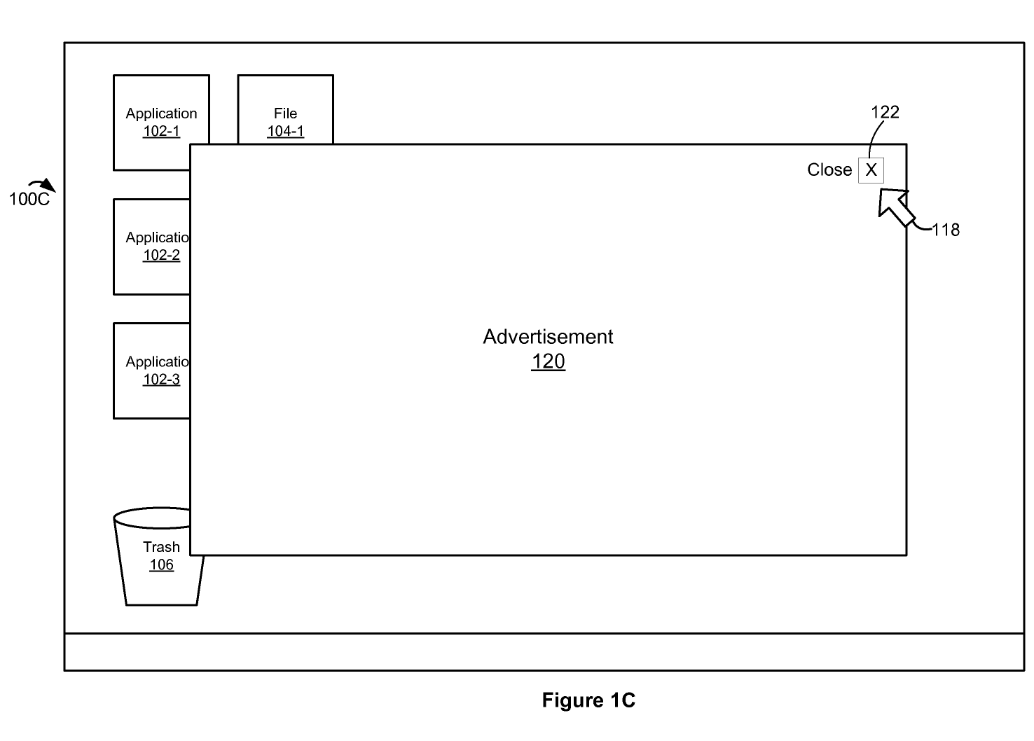

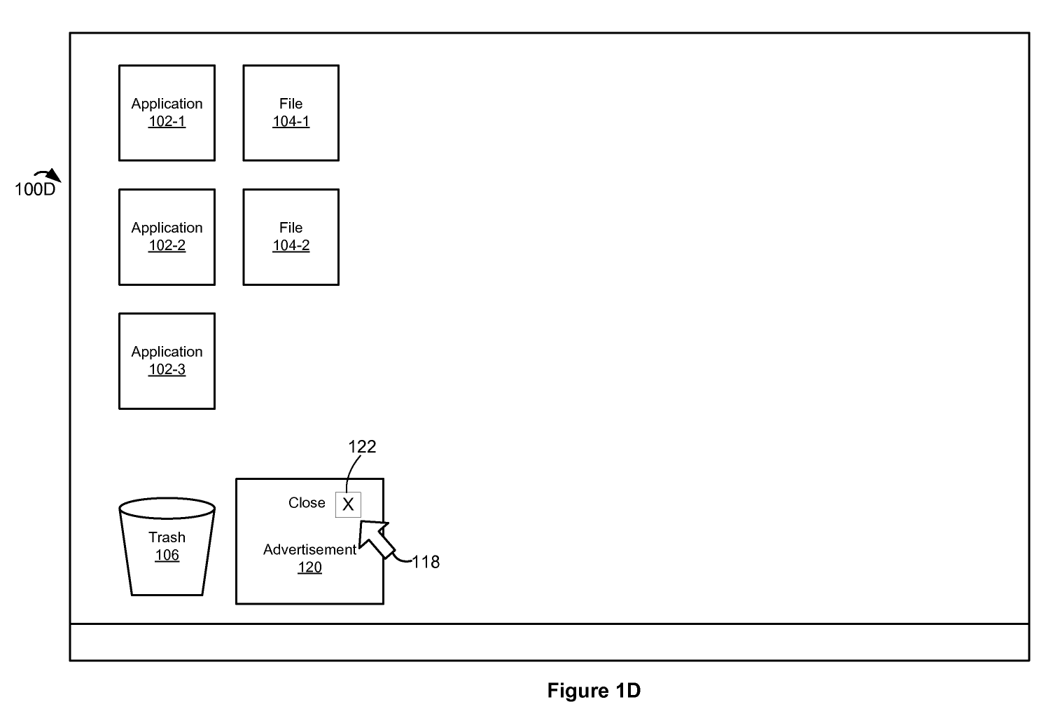

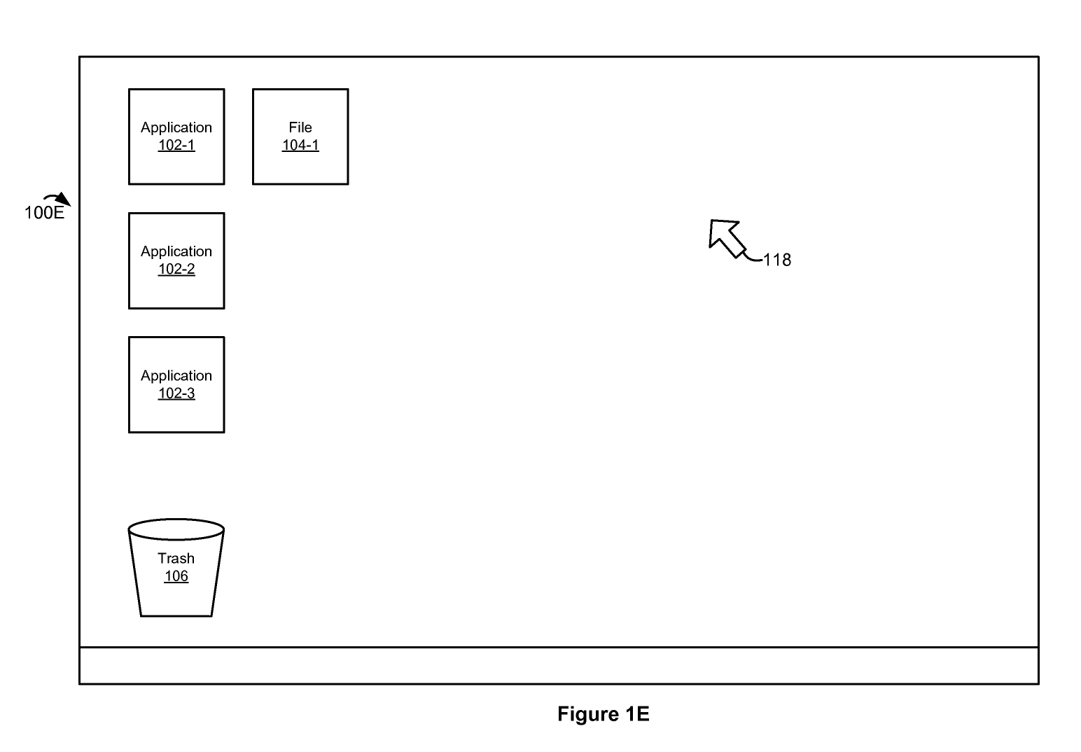

FIG. 1A is a schematic screenshot of a desktop user interface (UI) 100A in accordance with some embodiments. Displayed in the desktop UI 100A are icons corresponding to applications 102-1, 102-2, and 102-3 and files 104-1 and 104-2. The desktop UI 100A also includes a trash icon 106 for deleting items displayed in the UI 100A, such as an application 102 or file 104. In some embodiments, the trash icon 106 is provided by an operating system running on a computer displaying the UI 100A. In some embodiments, the trash icon 106 is associated with a program installed separately from the operating system, such as a program downloaded from the internet or installed from a CD-ROM or other appropriate computer-readable storage medium.

In some embodiments, to delete the file 104-2, the user selects the file 104-2 using a pointer icon 118 (e.g., by clicking on the file 104-2) and then drags the file 104-2 onto the trash icon 106 by performing a drag-and-drop operation 107 (e.g., using a mouse, trackball, touchpad, or other appropriate input device). In some embodiments, to delete the file 104-2, the user selects the file 104-2 using the pointer icon 118 and then selects one or more shortcut keys (e.g., the Delete key) on a keyboard. In some embodiments, as illustrated in the UI 100B (FIG. 1B), the user opens a command menu 108 (e.g., by right-clicking on the file 104-2) that provides various commands for manipulating the file 104-2 (e.g., open 109, cut 110, copy 112, delete 114, and rename 116) and then selects the delete command 114.

In response to any of these techniques for deleting the file 104-2, an advertisement 120 is displayed, as shown in the UI 100C or 100D (FIG. 1C or 1D). In some embodiments, the advertisement 120 is displayed as a pop-up banner superimposed on the UI 100C (FIG. 1C). In some embodiments the advertisement 120 is displayed as an item on the desktop, as shown in the UI 100D (FIG. 1D). For example, the advertisement 120 may be displayed adjacent to the trash icon 106, in a corner of the desktop UI 100D, or along an edge of the UI 100D. In some embodiments, the size of the advertisement 120 increases when the pointer icon 118 is positioned over the advertisement 120. In some embodiments, the advertisement 120 is displayed with a Close icon 122. In response to selection of the Close icon 122 using the pointer icon 118, display of the advertisement 120 is ceased and the file 104-2 is deleted (e.g., is moved to a file associated with the trash icon 106, or alternatively is permanently deleted), as illustrated in the UI 100E (FIG. 1E). Alternatively, the advertisement 120 may be displayed for a specified period of time (e.g., a specified number of seconds), after which display of the advertisement 120 is ceased. The file 104-2 may be deleted while the advertisement 120 is displayed or after display is ceased.

In some embodiments, the advertisement 120 includes text and/or a graphical image. In some embodiments, the advertisement 120 includes video.

In some embodiments, the advertisement 120 is displayed every time a file 104, application 102, or other item in the UI 100A is deleted. Alternatively, advertisement 120 is displayed every nth time an item is deleted, where n is an integer greater than one. In some embodiments, the same advertisement 120 is displayed in response to multiple delete commands. Alternatively, an advertisement 120 is selected from a group of available advertisements (e.g., at random, or by cycling sequentially through the group) each time an advertisement 120 is to be displayed.

In some embodiments, the advertisement 120 is specifically associated with file deletion, such that the advertisement 120 is only displayed in response to file deletion commands and not in response to other commands. Alternatively, the advertisement 120 may be associated with multiple commands (e.g., multiple commands in the menu 108, FIG. 1B) and may be displayed in response to any of the commands with which it is associated.

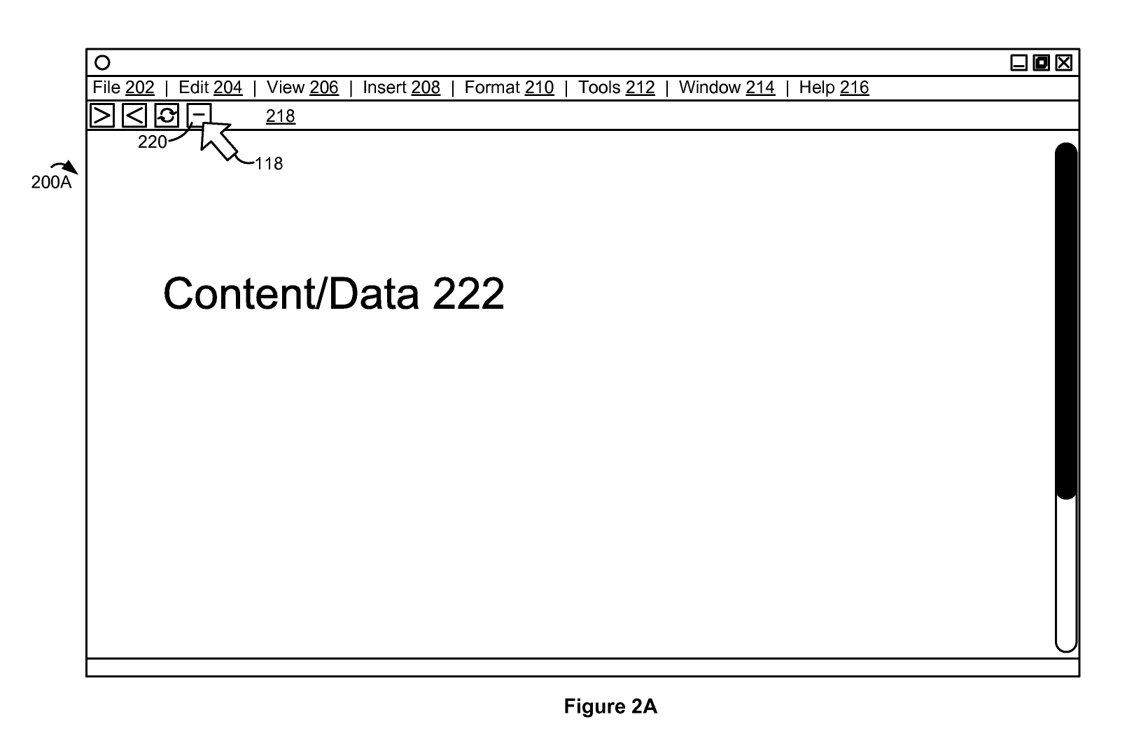

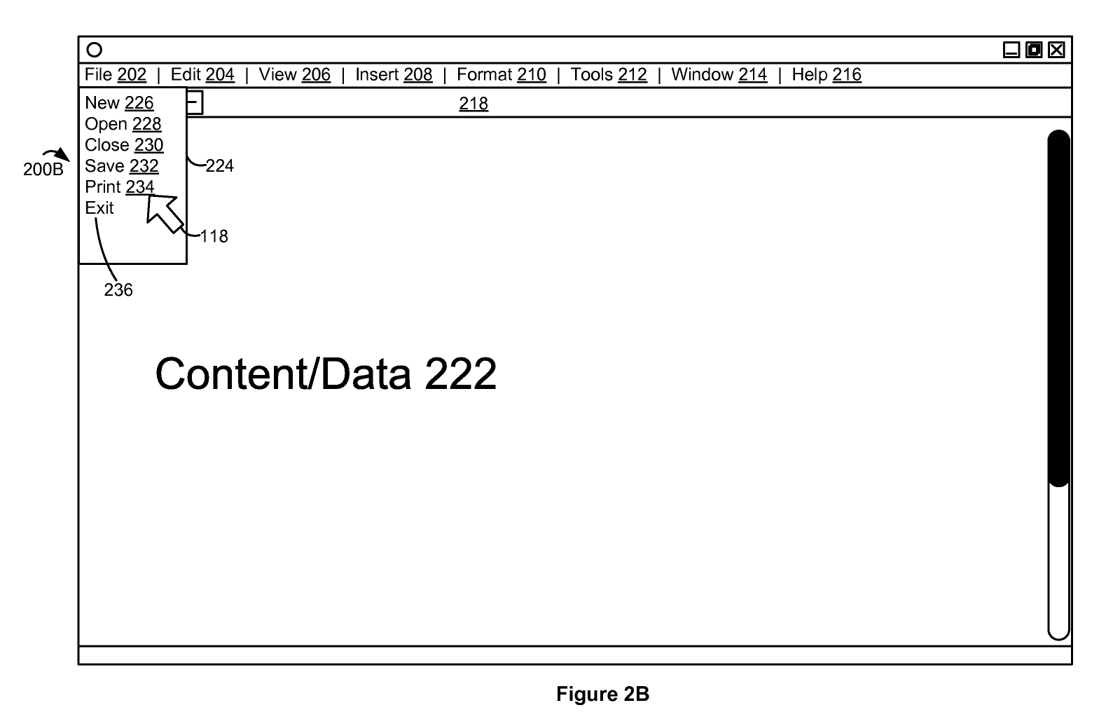

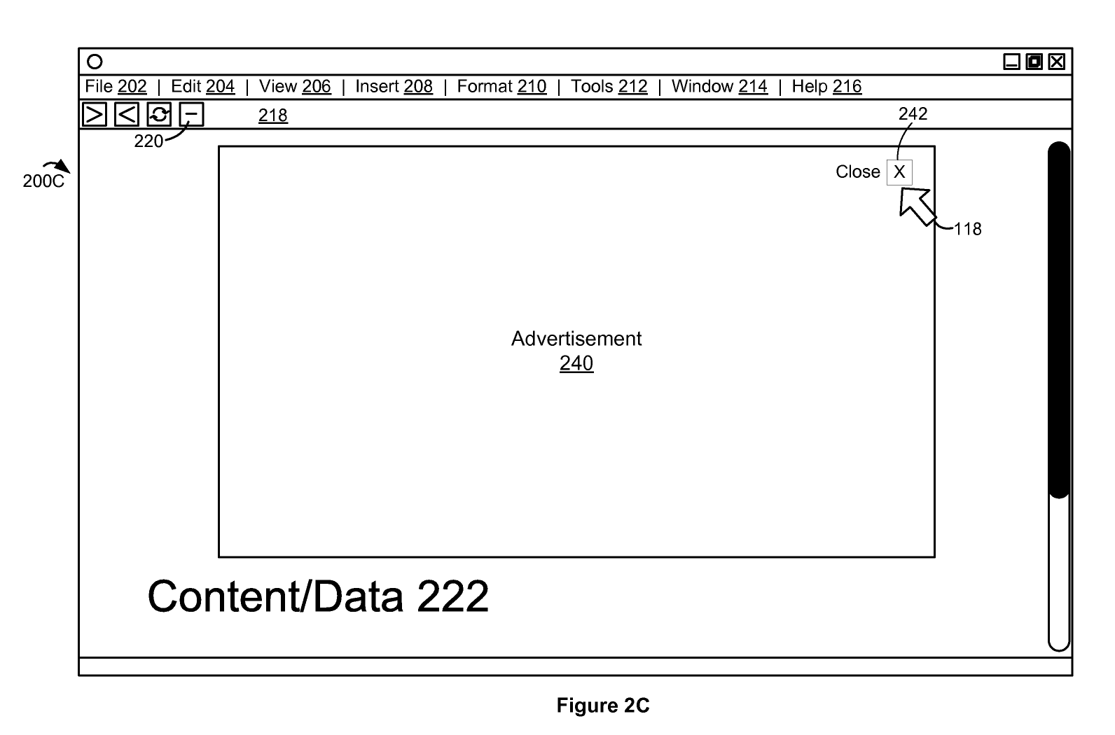

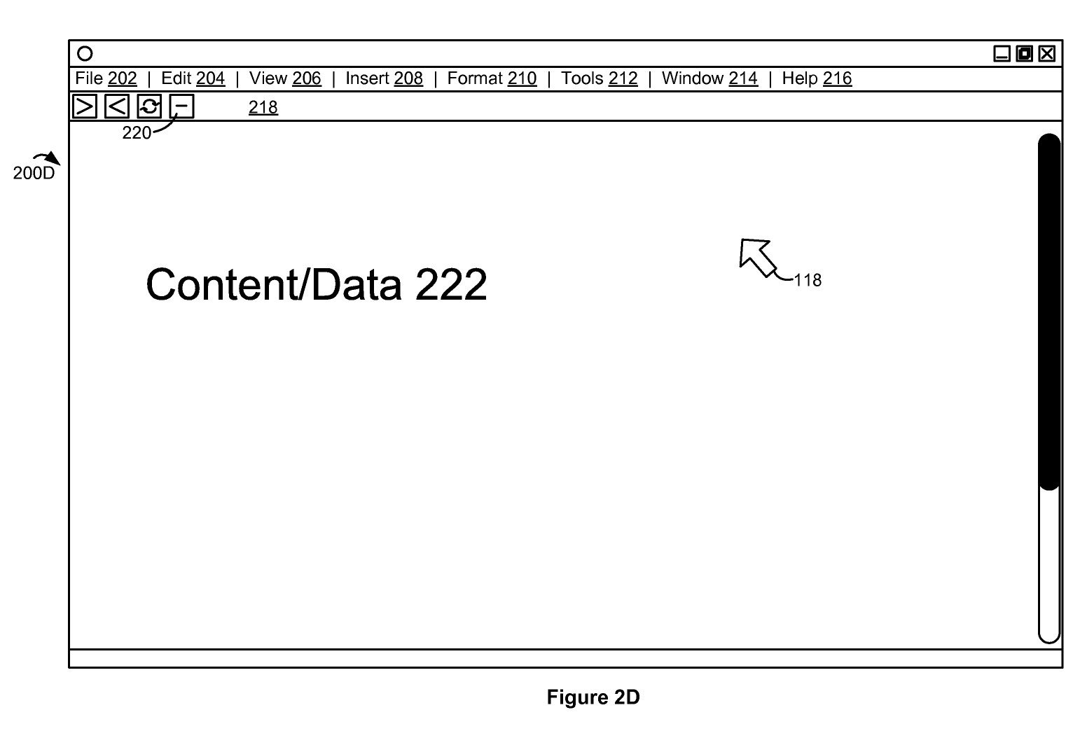

FIGS. 2A-2D illustrate another example of display of an advertisement in response to selection of a command to perform a function. FIG. 2A is a schematic screenshot of a UI 200A associated with a software application in accordance with some embodiments. The UI 200A includes various drop-down command menus (e.g., File 202, Edit 204, View 206, Insert 208, Format 210, Tools 212, Window 214, and Help 216). The UI 200A also includes one or more command icons 220. The UI 200A displays content or data 222 that may be manipulated using the software application associated with the UI 200A. For example, if the software application is a word processing program, the content or data 222 includes a document. If the software application is a spreadsheet program, the content or data 222 includes a spreadsheet. If the software application is a database program, the content or data 222 includes a database table. If the software application is a graphics program, the content or data 222 includes a graphical image. If the software application is a web browser, the content or data 222 includes a web page. Other examples are possible.

In some embodiments, the pointer icon 118 is used to select a command from a drop-down command menu. For example, as shown in the UI 200B (FIG. 2B), the Print command 234 is selected from the File drop-down menu 202 (e.g., by clicking on the Print command 234), which also includes New 226, Open 228, Close 230, Save 232, and Exit 236 commands. Alternatively, in some embodiments a command icon 220 (FIG. 2A) associated with a printing function is selected (e.g., by clicking on the icon 220). In some embodiments, one or more shortcut keys associated with the printing function are selected. In response to any of these methods of initiating printing, an advertisement 240 is displayed, as shown in the UI 200C (FIG. 2C) in accordance with some embodiments. In some embodiments, the advertisement 240 is displayed as a pop-up banner superimposed on the UI 200C. In some embodiments, the advertisement is displayed in the same window as the content/data 222. For example, the advertisement 240 may be displayed in a corner or along an edge of the window in which the content/data 222 is displayed. While the advertisement 240 of FIG. 2C is shown as occupying a majority of the area in the UI 200C, the size of the advertisement 240 may vary. For example, the advertisement 240 may have a size that does not substantially interfere with display of the content/data 222. In some embodiments, the size of the advertisement 240 increases when the pointer icon 118 is positioned over the advertisement 120. In some embodiments, the advertisement 240 includes text, a graphical image, and/or video.

In some embodiments, the advertisement 240 is displayed with a Close icon 242. In response to selection of the Close icon 242 using the pointer icon 118, the content/data 222 is output to a printer and display of the advertisement 240 is ceased, as illustrated in the UI 200D (FIG. 2D).

In some embodiments, the advertisement 240 is displayed every time content/data 222 is printed. Alternatively, advertisement 240 every nth time content/data 222 is printed, where n is an integer greater than one. In some embodiments, the same advertisement 240 is displayed in response to multiple print commands. Alternatively, an advertisement 240 is selected from a group of available advertisements (e.g., at random, or by cycling sequentially through the group) each time an advertisement 240 is to be displayed.

In some embodiments, the advertisement 240 is specifically associated with printing, such that the advertisement 240 is only displayed in response to print commands and not in response to other commands. Alternatively, the advertisement 240 may be associated with multiple commands (e.g., multiple commands in one or more of the drop-down menus File 202, Edit 204, View 206, Insert 208, Format 210, Tools 212, Window 214, and Help 216, and/or multiple commands associated with respective command icons 220) and may be displayed in response to any of the commands with which it is associated.

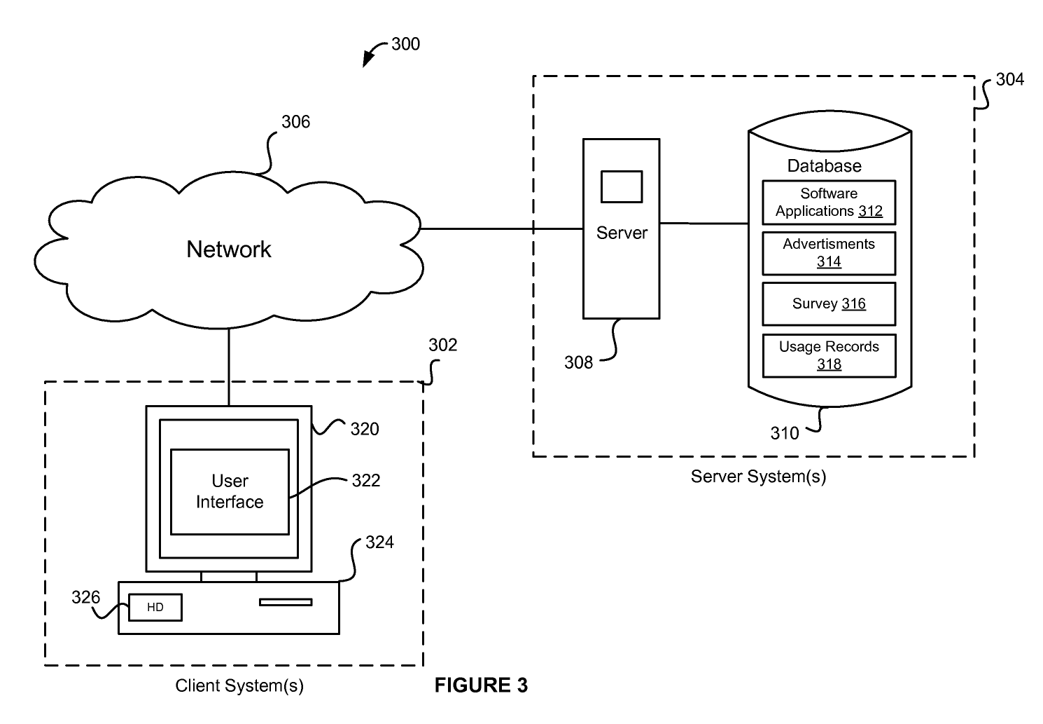

FIG. 3 is a block diagram illustrating a networked computer system 300 in accordance with some embodiments. The networked computer system 300 includes a server system 304 coupled to one or more client systems 302 by a network 306. The network 306 may be any suitable wired and/or wireless network and may include a local area network (LAN), wide area network (WAN), virtual private network (VPN), the Internet, metropolitan area network (MAN), or any combination of such networks.

The server system 304 includes a server 308 and a database 310. Server 308 serves as a front-end for the server system 304. Server 308, sometimes called a front end server, provides an interface between the server system 304 and the client systems 302. In some embodiments, the functions of server 308 may be divided or allocated among two or more servers.

The server system 304 stores software applications 312 that may be downloaded by client systems 312, as well as advertisements 314 (e.g., advertisements 120, FIG. 1C, and 240, FIG. 2C) to be downloaded along with the advertisements 314 for display in response to selection or activation of commands or functions in downloaded software applications 312. In some embodiments, advertisements 314 are embedded in a corresponding software application 312. In some embodiments, a user at a client computer 302 who wants to download a software application 312 to the client computer 302 first completes a survey 316 or a user profile, the results of which are used to select one or more advertisements 314 to be downloaded with (and, in some embodiments, embedded in) the software application 312 for display in response to selection or activation of commands or functions in the software application 312. The survey 316 or user profile allows the advertisements 314 to be personalized based on surveyed preferences of a user, thereby enabling targeted advertising.

In some embodiments, a user at a client computer 302 who wants to download a software application to the client computer 302 first agrees to a frequency with which advertisements will be displayed in response to selection of particular commands.

In some embodiments, the server system 304 periodically receives usage records 318 from client systems 302 indicating, for example, how often respective advertisements 314 have been displayed and/or how many times respective functions associated with respective advertisements have been performed. The usage records 318 allow software developers to determine how much to bill advertisers who provide the advertisements 314. Alternatively, a software developer may agree to make a specified charitable donation each time an advertisement 314 is displayed, and the usage records allow the software developer to determine the total charitable donation to be made.

It should be appreciated that the server system 304, including the server 308 and the database 310, may be implemented as a distributed system of multiple computers. However, for convenience of explanation, the server system 304 is described herein as being implemented on a single computer, which can be considered a single logical system.

A user interfaces with the server system 304 at a client system or device 302 (hereinafter called the client system for ease of reference). The client system 302 includes a computer 324 or computer controlled device, such as a personal digital assistant (PDA), cellular telephone or the like. The computer 324 typically includes one or more processors (not shown); memory, which may include volatile memory (not shown) and non-volatile memory such as a hard disk drive 326; and a display 320. The computer 324 may also have input devices such as a keyboard and a mouse (not shown). In some embodiments, a user may interact with the server system 304 via a user interface 322 (e.g., UI 100A-E, FIGS. 1A-1E, or UI 200A-D, FIGS. 2A-2D) presented on the display 320.

In some embodiments, the user interface 322 may be a part of a standalone application that is run on the client system 302. The standalone application may interface with the server system 304 via an application programming interface (API). For example, the standalone application may periodically download new advertisements 314 from the server system 304 for display in response to selection of a command to perform a function in the standalone application. The standalone application also may transmit usage records 318 from the client system 302 to the server system 304 indicating how often respective advertisements 314 have been displayed and/or how many times respective functions associated with respective advertisements have been performed. In some embodiments, the usage records 318 include information regarding specific instances of execution of respective functions. For example, if advertisements are displayed in response to selection of file deletion commands (e.g., as illustrated in FIGS. 1A-1E), the usage records 318 may include detailed file information including the file size, file type, and/or title of each deleted file along with the date of deletion. Alternatively, the usage records 318 may include a summary of deleted files that provides the number and total size of deleted files. Usage records 318 may be transmitted each time a function is performed or an advertisement is displayed, or transmitted periodically (e.g., once a day or once a week). If internet or other network access is temporarily unavailable, the client system 302 may store the usage records 318 for transmission once network access has been reestablished.

In some other embodiments, the user interface 322 may be a web-based user interface. That is, the user interface 322 includes one or more web pages. It is noted that a single web page can contain multiple frames, each of which may appear (when displayed by a browser application) to be a distinct web page. The web page(s) may be written in the Hypertext Markup Language (HTML), Extensible Markup Language (XML), or any other suitable language for preparing web pages, and may include one or more scripts for interfacing with the server system 304. For example, the web page(s) may include a script-based module (e.g., written in JavaScript, AJAX, ECMAScript, Perl, or any other suitable scripting language) that interfaces with the server system 304 via an application programming interface (API). The script-based module receives data (e.g., content/data 222, FIGS. 2A-2D) and advertisements 314 from the server system 304, manages the rendering of the data and advertisements 314 at the client system 302, and also performs the client-side aspects of other tasks, such as receiving user input selecting commands and transmitting the commands to the server system 304.

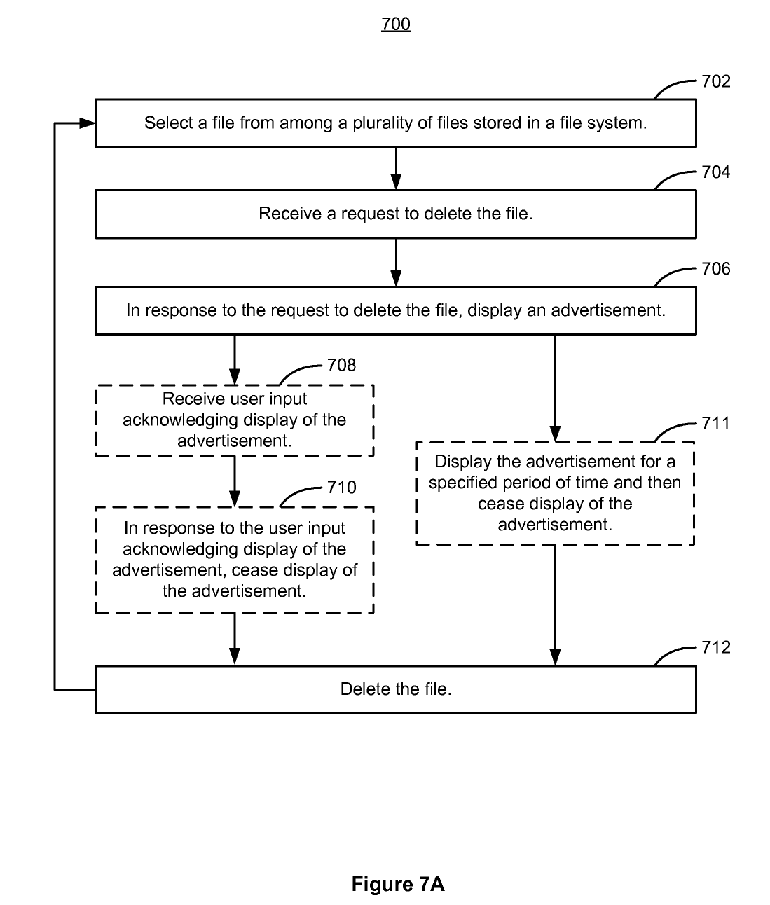

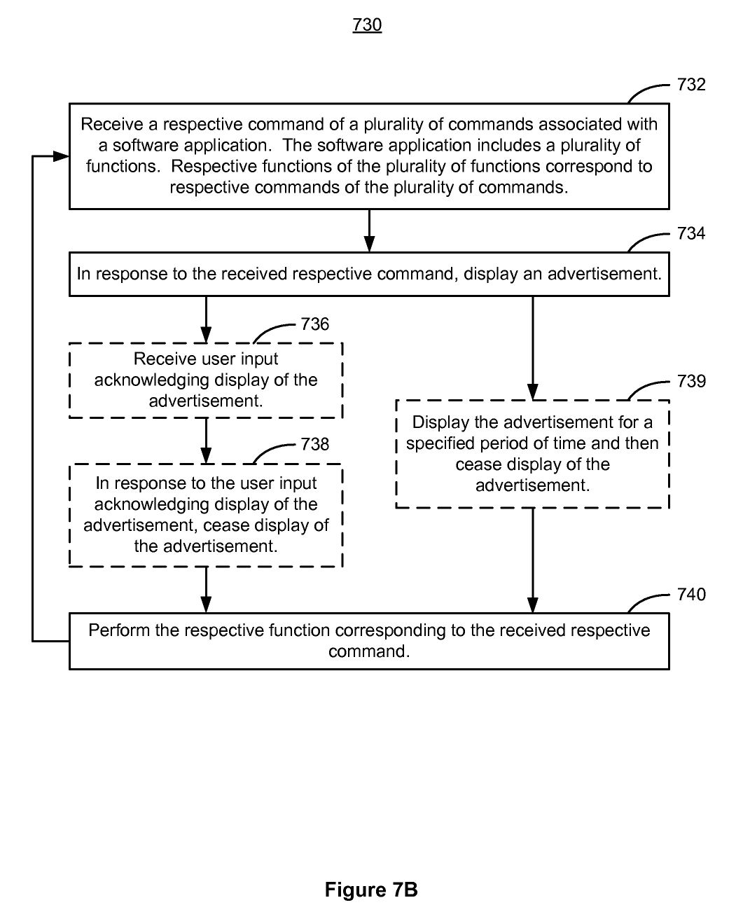

A client system 302 may perform the methods 700 (FIG. 7A) and/or 730 (FIG. 7B) in accordance with some embodiments. Alternatively, performance of various operations in the methods 700 and/or 730 may be divided between the client system 302 and server system 304.

Instead of downloading a software application 312 and one or more associated (e.g., embedded) advertisements 314 from the server system 304 to the client system 302, a software application and one or more associated advertisements may be installed on the system 302 from a CD-ROM or other suitable computer-readable storage medium. Therefore, a system 302 that displays a UI 322 (e.g., UI 100A-E, FIGS. 1A-1E, or UI 200A-D, FIGS. 2A-2D) need not have a network connection. A software application installed from a suitable computer-readable medium may be configured to ensure that the application cannot be installed without also installing associated advertisements. For example, the advertisements may be embedded in the application. Software developers thus are assured that users who receive unauthorized copies of software applications will view the advertisements. Software developers can estimate the extent of unauthorized copying when determining advertising rates, and therefore avoid losses due to piracy.

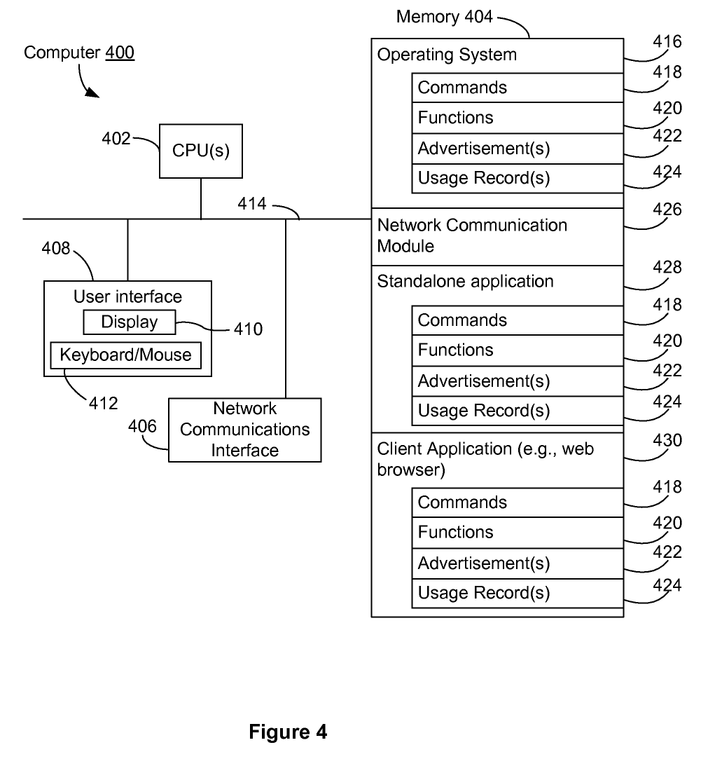

FIG. 4 is a block diagram illustrating a computer or computer controlled device 400, such as a personal digital assistant (PDA), cellular telephone or the like, in accordance with some embodiments. The computer 400 is an example of an implementation of a client system 302 in accordance with some embodiments. The computer 400 typically includes one or more processors 402, one or more network or other communications interfaces 406, memory 404, and one or more communication buses 414 for interconnecting these components. The communication buses 414 may include circuitry (sometimes called a chipset) that interconnects and controls communications between system components. The client computer 400 may also include user interface hardware 408 comprising a display device 410 and a keyboard and/or mouse (or other pointing device such as a trackball or touchpad) 412. Memory 404 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 404 may optionally include one or more storage devices remotely located from the processor(s) 402. Memory 404, or alternately non-volatile memory device(s) within memory 404, comprises a computer readable storage medium. In some embodiments, memory 404 stores the following programs, modules, and data structures, or a subset thereof:
an operating system 416 that includes procedures for handling various basic system services and for performing hardware dependent tasks;
a network communication module 426 that is used for connecting the client computer 400 to other computers via the one or more communication network interfaces 406 and one or more communication networks, such as the Internet, other wide area networks, local area networks, metropolitan area networks, and so on;
a standalone software application 428; and
a web browser or other client application 430.

In some embodiments, the operating system 416, standalone application 428, and/or client application 430 include respective commands 418, respective functions 420 associated with respective commands 418, one or more advertisements 422, and one or more usage records 424. In some embodiments, a respective advertisement 422 is associated with a respective command 418 and function 420, such that the respective advertisement 422 is displayed in response to selection of the respective command 418 (and, in some embodiments, prior to execution of the respective function 420). In some embodiments, a respective advertisement 422 is associated with a plurality of respective commands 418 and functions 420, such that the respective advertisement 422 may be displayed in response to selection of any or all of the respective commands 418 of the plurality (and, in some embodiments, prior to execution of any or all respective functions 420 of the plurality).

In some embodiments, the operating system 416, standalone application 428, and/or client application 430 include instructions for performing the methods 700 (FIG. 7A, below) and/or 730 (FIG. 7B, below).

Each of the above identified elements in FIG. 4 may be stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 404 may store a subset of the modules and data structures identified above. Furthermore, memory 404 may store additional modules and data structures not described above.

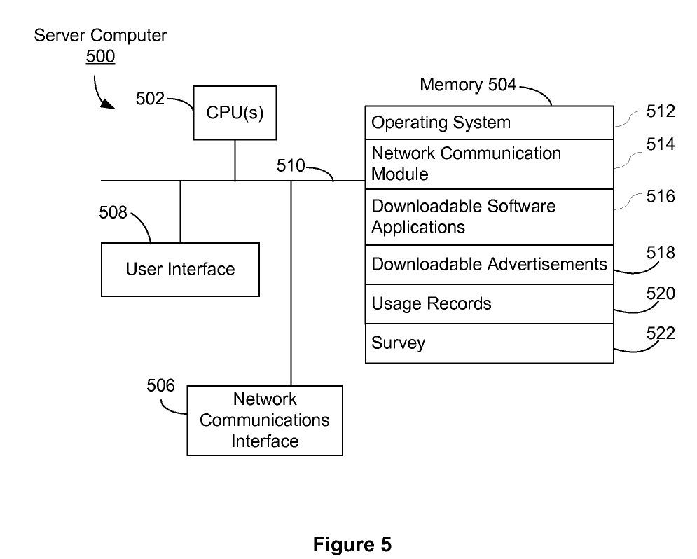

FIG. 5 is a block diagram illustrating a server computer 500 in accordance with some embodiments. The server computer 500 is an example of an implementation of a server system 304 (FIG. 3) in accordance with some embodiments. The server computer 500 typically includes one or more processing units (CPUs) 502, one or more network or other communications interfaces 506, memory 504, and one or more communication buses 510 for interconnecting these components. The communication buses 510 may include circuitry (sometimes called a chipset) that interconnects and controls communications between system components. The server system 500 optionally may include user interface hardware 508, which may include a display device (not shown), and a keyboard and/or a mouse (not shown). Memory 504 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 504 may optionally include one or more storage devices remotely located from the CPU(s) 502. Memory 504, or alternately non-volatile memory device(s) within memory 504, comprises a computer readable storage medium. In some embodiments, memory 504 stores the following programs, modules and data structures, or a subset thereof:
an operating system 512 that includes procedures for handling various basic system services and for performing hardware dependent tasks;
a network communication module 514 that is used for connecting the server system 500 to other computers via the one or more communication network interfaces 506 and one or more communication networks, such as the Internet, other wide area networks, local area networks, metropolitan area networks, and so on;
one or more downloadable software applications 516;
one or more downloadable advertisements 518;
usage records 520 (e.g., transmitted from client systems 302) (e.g., indicating how often respective advertisements 518 have been displayed and/or how many times respective functions associated with respective advertisements have been performed); and
a survey 522 (or user profile) to be completed by a user (e.g., a user at a client system 302) prior to downloading a software application 516, to enable personalization of advertisements 518 downloaded with the software application 516.

In some embodiments, the downloadable software applications 516 include instructions for performing the methods 700 (FIG. 7A) and/or 730 (FIG. 7B).

Each of the above identified elements in FIG. 5 may be stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 504 may store a subset of the modules and data structures identified above. Furthermore, memory 504 may store additional modules and data structures not described above.

Although FIG. 5 shows a “server computer,” FIG. 5 is intended more as a functional description of the various features which may be present in a set of servers than as a structural schematic of the embodiments described herein. In practice, and as recognized by those of ordinary skill in the art, items shown separately could be combined and some items could be separated. For example, some items shown separately in FIG. 5 could be implemented on single servers and single items could be implemented by one or more servers.

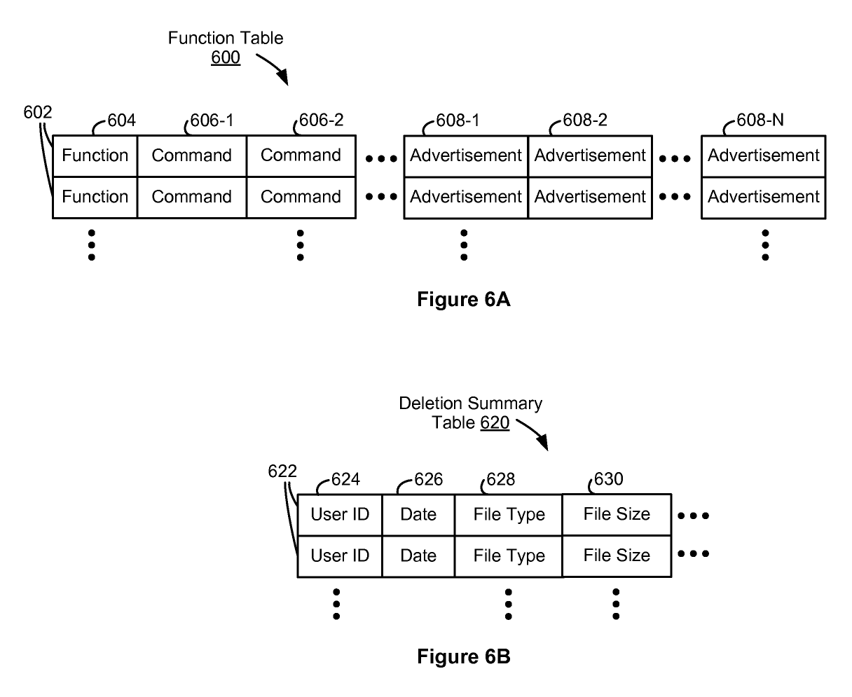

FIG. 6A is a diagram illustrating a table 600 that maps respective functions 604 to commands 606 and advertisements 608 in accordance with some embodiments. In some embodiments, the table 600 is included in a software application (e.g., operating system 416, standalone application 428, or client application 430, FIG. 4, or software application 312, FIG. 3) to enable display of an advertisement 608 (e.g., an advertisement 422, FIG. 4, or 314, FIG. 3) and execution of a function (e.g., a function 420, FIG. 4) in response to a received command (e.g., a command 418, FIG. 4). The table 600 includes a row 602 for each respective function 604 in the table. Each row 602 includes a field specifying the respective function 604 and one or more fields specifying commands 606 that may be used to activate the respective function 604. For example, a command 606-1 may correspond to an item in a drop-down menu while a command 606-2 may correspond to one or more short-cut keys. Each row 602 also includes one or more fields specifying an advertisement 608 to be displayed in response to selection of a command 606 associated with a respective function 604. Where a row 602 includes multiple advertisements 608 (e.g., N advertisements 608-1 through 608-N, where N is an integer greater than one), one of the multiple advertisements 608 is chosen for display in response to receipt of a command 606 associated with the respective function 604. For example, successive advertisements 608 may be selected in round-robin fashion in response to successive commands 606, or an advertisement 608 may be chosen at random from among the advertisements 608-1 through 608-N.

FIG. 6B is a diagram illustrating a deletion summary table 620 in accordance with some embodiments. The deletion summary table 620 stores data corresponding to specific instances of performance of a delete function (e.g., as illustrated in FIGS. 1A-1E). The table 620 includes a row 622 corresponding to each deleted file. Each row 622 includes a user ID 624, a date of deletion 626, a file type (e.g., file format) 628, and a file size 630 (e.g., in megabytes). The table 620 may include one or more other fields, such as a field storing the title of each deleted file. The data stored in the table 620 may be transmitted to a server (e.g., as usage records 318 transmitted to a server system 304 for storage in a database 310). Data structures analogous to the table 620 that store information regarding specific instances of execution of other functions may be maintained.

FIG. 7A is a flow diagram illustrating a computer-implemented method 700 of deleting a file in accordance with some embodiments. In some embodiments, the method 700 is performed on a computer system such as the client system 302 (FIG. 3).

In the method 700, a file (e.g., file 104-2, FIG. 1A) is selected (702) from among a plurality of files stored in a file system. For example, the file 104-2 may be selected using a pointer icon 118 (FIG. 1A) to click on the file 104-2.

A request is received (704) to delete the file. In some embodiments, the request to delete the file corresponds to activation of a file deletion command. For example, a drag-and-drop operation 107 (FIG. 1A) is performed to drag the file 104-2 into the trash icon 106. In other examples, the delete command 114 is selected from the menu 108 (FIG. 1B) or a delete key is selected on a keyboard.

In response to the request to delete the file, an advertisement (e.g., advertisement 120, FIG. 1C or 1D) is displayed (706). In some embodiments, the advertisement is associated with the file deletion command. For example, the advertisement 120 may be an advertisement 608 mapped to a file deletion command 606 in the table 600 (FIG. 6A).

The file is deleted (712). For example, in UI 100E (FIG. 1E), the file 104-2 has been deleted and therefore is no longer displayed.

In some embodiments, user input acknowledging display of the advertisement (e.g., user selection of the Close icon 122, FIG. 1C or 1D) is received (708). In response to the user input acknowledging display of the advertisement, display of the advertisement is ceased (710). In some embodiments, the file is also deleted (712) in response to the user input acknowledging display of the advertisement.

In some embodiments, the advertisement is displayed (711) for a specified period of time, after which display of the advertisement ceases.

In some embodiments, one or more additional files from the plurality of files are deleted, for example by repeating the operations 702-712. Summary information for the deleted files is recorded (e.g., in a table 620, FIG. 6B). The summary information is transmitted to a server computer.

In some embodiments, a new advertisement (e.g., an advertisement 314, FIG. 3) is downloaded to display in response to subsequent requests to delete files received. In some embodiments, the new advertisement is selected based at least in part on the transmitted summary information (e.g., based at least in part on usage records 318, FIG. 3).

The method 700 thus provides a specific example of display of an advertisement in response to user selection of a command associated with a function to be performed by a software application. While the method 700 includes a number of operations that appear to occur in a specific order, it should be apparent that the method 700 can include more or fewer operations, which can be executed serially or in parallel. For example, operations 710 and 712 may be performed in parallel. An order of two or more operations may be changed and two or more operations may be combined into a single operation. For example, operation 712 may be performed prior to operation 706, such that the advertisement is displayed after the file is deleted.

FIG. 7B is a flow diagram illustrating a computer-implemented method 730 of executing a particular function in a software application in accordance with some embodiments. In some embodiments, the method 730 is performed on a computer system such as the client system 302 (FIG. 3).

In the method 730, a respective command of a plurality of commands associated with a software application is received (732). The software application includes a plurality of functions. Respective functions of the plurality of functions correspond to respective commands of the plurality of commands.

In some embodiments, the respective function corresponding to the received respective command is operable to manipulate any of a plurality of datasets accessible by the software application. For example, the software application could be an operating system, the plurality of datasets could include a plurality of files, and the plurality of functions includes a plurality of file management operations executable by the operating system. In another example, the software application could include a word processing application, the plurality of datasets could include a plurality of documents, and the plurality of functions could include a plurality of word processing operations for manipulating selected documents of the plurality of documents. In yet another example, the software application could include a spreadsheet application, the plurality of datasets could include a plurality of spreadsheets, and the plurality of functions could include a plurality of spreadsheet processing operations for manipulating selected spreadsheets of the plurality of spreadsheets. In yet another example, the software application could include a database application, the plurality of datasets could include a plurality of tables, and the plurality of functions could a plurality of database operations for manipulating one or more tables selected from among the plurality of tables. Other examples are possible.

In some embodiments, receiving the respective command comprises detecting selection of one or more shortcut keys. In some embodiments, receiving the respective command comprises detecting selection of a menu option from a drop-down menu (e.g., selection of “Print” 234 from the File menu 202, FIG. 2B) or other menu (e.g., selection of “Delete” 114 from the menu 108, FIG. 1B). In some embodiments, receiving the respective command comprises detecting selection of a command icon 220 (FIG. 2A).

In response to the received respective command, an advertisement (e.g., advertisement 120, FIG. 1C or 1D, or 240, FIG. 2C) is displayed (734). In some embodiments, the advertisement is displayed as a pop-up banner. In some embodiments, the advertisement is associated with the respective function corresponding to the received respective command. In some embodiments, the advertisement is selected from a plurality of available advertisements in accordance with a survey or user profile completed by a user of the software application (e.g., a survey 316, FIG. 3) when downloading or otherwise installing the software application. In some embodiments, while display of an advertisement occurs in response to the received respective command, the advertisement is selected from a plurality of available advertisements in accordance with content of a document or other data for which the respective function is to be performed.

The respective function corresponding to the received respective command is performed (740) (e.g., the file 104-2 is deleted, as shown in FIG. 1E, or the content/data 222 of FIGS. 2A-2D is printed).

In some embodiments, user input acknowledging display of the advertisement (e.g., user selection of the Close icon 122, FIG. 1C or 1D, or 242, FIG. 2C) is received (736). In response to the user input acknowledging display of the advertisement, display of the advertisement is ceased (738). In some embodiments, the respective function is also performed (740) in response to the user input acknowledging display of the advertisement.

In some embodiments, the advertisement is displayed (739) for a specified period of time, after which display of the advertisement ceases.

In some embodiments, the operations 732-740 are performed repeatedly: the respective command is repeatedly received and in response the advertisement is repeatedly displayed. In some embodiments, a count of receipt of the respective command (e.g., a count of how often the respective command is received) is recorded and the count of receipt is transmitted (e.g., periodically transmitted) to a computer server (e.g., as a usage record 318, FIG. 3). In some embodiments, a count of receipt of the respective command is recorded and the advertisement is displayed when the count exceeds a predefined limit, such that the advertisement is only displayed in response to a fraction of occurrences of the respective command. In some embodiments, a count of display of the advertisement is recorded and the count of display is transmitted (e.g., periodically transmitted) to a computer server (e.g., as a usage record 318, FIG. 3). In some embodiments, a new advertisement is downloaded (e.g., is periodically downloaded) for subsequent display in response to receiving the respective command.

The method 730 allows software to display advertising based on performance of software functions instead of content provided using the software. While the method 730 includes a number of operations that appear to occur in a specific order, it should be apparent that the method 730 can include more or fewer operations, which can be executed serially or in parallel. For example, operations 738 and 740 may be performed in parallel. An order of two or more operations may be changed and two or more operations may be combined into a single operation. For example, operation 740 may be performed prior to operation 734, such that the advertisement is displayed after the respective function is performed. The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of deleting a file, comprising:
selecting a file from among a plurality of files stored in a file system;
receiving a request to delete the file;
in response to the request to delete the file, displaying an advertisement; and
deleting the file.

2. The computer-implemented method of claim 1, further comprising:
receiving user input acknowledging display of the advertisement; and
in response to the user input acknowledging display of the advertisement, ceasing display of the advertisement;
wherein the file is deleted in response to the user input acknowledging display of the advertisement.

3. The computer-implemented method of claim 1, wherein:
the request to delete the file corresponds to activation of a file deletion command; and
the advertisement is associated with the file deletion command.

4. The computer-implemented method of claim 1, further comprising:
deleting one or more additional files from the plurality of files;
recording summary information for the deleted files; and
transmitting the summary information to a server computer.

5. The computer-implemented method of claim 4, wherein the summary information includes information to determine an amount of a charitable contribution to be made in response to the deleting.

6. The computer-implemented method of claim 4, further comprising:
downloading a new advertisement to display in response to requests to delete files, wherein the new advertisement is selected based at least in part on the transmitted summary information.

7. A computer-implemented method of executing a function of a software application that includes a plurality of functions, wherein respective functions of the plurality of functions correspond to respective commands of a plurality of commands associated with the software application, the method comprising:
receiving a respective command of the plurality of commands;
in response to the received respective command, displaying an advertisement; and
performing the respective function corresponding to the received respective command.

8. The computer-implemented method of claim 7, further comprising:
receiving user input acknowledging display of the advertisement; and
in response to the user input acknowledging display of the advertisement, ceasing display of the advertisement;
wherein the respective function corresponding to the respective command is performed in response to the user input acknowledging display of the advertisement.

9. The computer-implemented method of claim 7, wherein the advertisement is associated with the respective function corresponding to the received respective command.

10. The computer-implemented method of claim 7, wherein the software application is an operating system.

11. The computer-implemented method of claim 7, wherein the advertisement is displayed as a pop-up banner.

12. The computer-implemented method of claim 7, further comprising:
repeatedly receiving the respective command;
recording a count of receipt of the respective command; and
transmitting the count of receipt to a computer server.

13. The computer-implemented method of claim 12, wherein the count of receipt corresponds to an amount of a charitable contribution.

14. The computer-implemented method of claim 7, further comprising:
repeatedly receiving the respective command;
repeatedly displaying the advertisement, in response to the repeated receiving.

15. The computer-implemented method of claim 14, further comprising:
periodically downloading a new advertisement to display in response to receiving the respective command.

16. The computer-implemented method of claim 14, further comprising:
recording a count of display of the advertisement; and
transmitting the count of display to a computer server.

17. The computer-implemented method of claim 16, wherein the count of display corresponds to an amount of a charitable contribution.

18. The computer-implemented method of claim 7, further comprising:
repeatedly receiving the respective command;
recording a count of receipt of the respective command; and
displaying the advertisement when the count exceeds a predefined limit.

19. The computer-implemented method of claim 7, wherein the advertisement is selected from a plurality of available advertisements in accordance with a survey completed by a user of the software application.

20. The computer-implemented method of claim 7, wherein receiving the respective command comprises detecting selection of one or more shortcut keys.

21. The computer-implemented method of claim 7, wherein receiving the respective command comprises detecting selection of a menu option from a drop-down menu.

22. The computer-implemented method of claim 7, wherein the respective function corresponding to the received respective command is operable to manipulate any of a plurality of datasets accessible by the software application.

23. The computer-implemented method of claim 22, wherein:
the software application is an operating system;
the plurality of datasets comprises a plurality of files; and
the plurality of functions comprises a plurality of file management operations executable by the operating system.

24. The computer-implemented method of claim 22, wherein:
the software application comprises a word processing application;
the plurality of datasets comprises a plurality of documents; and
the plurality of functions comprises a plurality of word processing operations.

25. The computer-implemented method of claim 22, wherein:
the software application comprises a spreadsheet application;
the plurality of datasets comprises a plurality of spreadsheets; and
the plurality of functions comprises a plurality of spreadsheet processing operations.

26. The computer-implemented method of claim 22, wherein:
the software application comprises a database application;
the plurality of datasets comprises a plurality of tables; and
the plurality of functions comprises a plurality of database operations.

27. A computer system comprising:
memory;
a display;
one or more processors; and
one or more programs stored in the memory and configured for execution by the one or more processors, the one or more programs comprising:
instructions to select a file from among a plurality of files stored in a file system;
instructions to receive a request to delete the file;
instructions to display an advertisement in response to the request to delete the file; and
instructions to delete the file.

28. A computer system comprising:
memory;
a display;
one or more processors; and
one or more programs stored in the memory and configured for execution by the one or more processors, the one or more programs comprising:
instructions to receive a command of a plurality of commands associated with a software application, wherein respective commands of the plurality of commands correspond to respective functions of a plurality of functions included in the software application;
instructions to display an advertisement in response to the received command; and
instructions to perform the respective function corresponding to the received command.

29. A computer readable storage medium storing one or more programs configured to be executed by a computer system, the one or more programs comprising:
instructions to select a file from among a plurality of files stored in a file system;
instructions to receive a request to delete the file;
instructions to display an advertisement in response to the request to delete the file; and
instructions to delete the file 30. A computer readable storage medium storing one or more programs configured to be executed by a computer system, the one or more programs comprising:
instructions to receive a command of a plurality of commands associated with a software application, wherein respective commands of the plurality of commands correspond to respective functions of a plurality of functions included in the software application;
instructions to display an advertisement in response to the received command; and
instructions to perform the respective function corresponding to the received command.
